(19) United States
(12) Patent Application Publication
(10) Pub. No.: US 2023/0246242 A1
(43) Pub. Date: Aug. 3, 2023

(54) ELECTROACTIVE MATERIALS FOR HIGH-PERFORMANCE BATTERIES

(71) Applicant: GM GLOBAL TECHNOLOGY OPERATIONS LLC, Detroit, MI (US)

(72) Inventors: Mengyan HOU, Shanghai (CN); Meiyuan WU, Shanghai (CN); Si CHEN, Shanghai (CN); Xiachao QUE, Shanghai (CN); Haijing LIU, Shanghai (CN)

(73) Assignee: GM GLOBAL TECHNOLOGY OPERATIONS LLC, Detroit, MI (US)

(21) Appl. No.: 17/884,234

(22) Filed: Aug. 9, 2022

(30) Foreign Application Priority Data
Jan. 28, 2022 (CN) 202210106719.8

(51) Int. Cl. H01M 10/058; H01M 4/505; H01M 4/525; H01M 4/36; H01M 4/587; H01M 4/62; H01M 10/0525; H01M 10/0567; H01M 50/463

(52) U.S. Cl. CPC H01M 10/058; H01M 4/505; H01M 4/525; H01M 4/364; H01M 4/587; H01M 4/62; H01M 10/0525; H01M 10/0567; H01M 50/463; H01M 2004/021

(57) ABSTRACT

An electrochemical cell that cycles lithium ions is provided. The electrochemical cell includes a positive electrode having a positive electroactive material selected from the group consisting of LiNiₓM₂₋ₓO₂ (where M is selected from the group consisting of cobalt, manganese, aluminum, and combinations thereof and x≥0.8), and a negative electrode having a negative electroactive composite material including a carbonaceous material and silicon oxide (SiOₓ, 0.95≤x≤1.05). The positive electrode has a single-sided loading capacity at room temperature between about 4.5 mAh/cm² and about 6.5 mAh/cm². The negative electrode has a single-sided loading capacity at room temperature between about 4.5 mAh/cm² and about 5.5 mAh/cm².

### CROSS-REFERENCE TO RELATED APPLICATIONS

This application claims the benefit of Chinese Patent Application No. 202210106719.8 filed on Jan. 28, 2022. The entire disclosure of the application referenced above is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

### SUMMARY

This section provides a general summary of the disclosure, and is not a comprehensive disclosure of its full scope or all of its features.

The present disclosure relates to electroactive materials and electrochemical cells including the same.

In various aspects, the present disclosure provides an electrochemical cell that cycles lithium ions. The electrochemical cell may include a positive electrode having a single-sided loading capacity at room temperature of greater than or equal to about 4.5 mAh/cm² to less than or equal to about 6.5 mAh/cm², and a negative electrode having a single-sided loading capacity at room temperature of greater than or equal to about 4.5 mAh/cm² to less than or equal to about 5.5 mAh/cm². The positive electrode may include a positive electroactive material selected from the group consisting of: LiNiₓM₂₋ₓO₂ (where M is selected from the group consisting of cobalt, manganese, aluminum, and combinations thereof and x≥0.8). The negative electrode may include a negative electroactive composite material including a carbonaceous material and silicon oxide (SiOₓ, 0.95≤x≤1.05).

In one aspect, the positive electrode may have a press density greater than or equal to about 3.2 g/cm³ to less than or equal to about 3.8 g/cm³. The positive electrode may have a porosity greater than or equal to about 25 vol. % to less than or equal to about 35 vol. %.

In one aspect, the positive electrode may have a width greater than or equal to about 50 mm to less than or equal to about 500 mm. The negative electrode may have a length greater than or equal to about 50 mm to less than or equal to about 500 mm.

In one aspect, the positive electrode may have a moisture content of less than or equal to about 600 ppm.

In one aspect, the electrochemical cell may further include a separator disposed between the positive electrode and the negative electrode. The separator may have a thickness greater than or equal to about 17 micrometers (μm) to less than or equal to about 23 μm. The separator may have a porosity greater than or equal to about 35 vol. % to less than or equal to about 55 vol. %.

In one aspect, the electrochemical cell may further include an electrolyte dispersed in one or both of the positive electrode and the negative electrode. The electrochemical cell may also include an electrolyte additive. For example, the electrochemical cell may include greater than or equal to about 0.1 wt. % to less than or equal to about 10 wt. % of the electrolyte additive. The electrolyte additive may be selected from the group consisting of: vinylene carbonate (VC), vinylethylene carbonate (VEC), ethylene sulfate (DTD), 1, 3-propone sulfone (PS), tris(trimethylsilyl) phosphite (TMSPi), trimethylene sulfate (TMS), succinonitrile (SN), triphenylamine (Ph₃N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof.

In one aspect, the negative electrode may have a press density greater than or equal to about 1.4 g/cm³ to less than or equal to about 1.8 g/cm³. The negative electrode may have a porosity greater than or equal to about 30 vol. % to less than or equal to about 40 vol. %.

In one aspect, the negative electrode may have a second width that is at least two times greater than a first width of the positive electrode. The negative electrode may have a second length that is at least two times greater than a first length of the positive electrode.

In one aspect, the second width may be less than ten times greater than the first width. The second length may be less than ten times greater than the first length.

In one aspect, the negative electrode may have a width greater than or equal to about 50 mm to less than or equal to about 500 mm. The negative electrode may have a length greater than or equal to about 50 mm to less than or equal to about 500 mm.

In one aspect, the negative electrode may have a moisture content of less than or equal to about 500 ppm.

In one aspect, the negative electrode may include greater than or equal to about 92 wt. % to less than or equal to about 98 wt. % of the carbonaceous material, and greater than or equal to about 2 wt. % to less than or equal to about 8 wt. % of silicon oxide (SiOₓ, 0.95≤x≤1.05).

In one aspect, the carbonaceous material may be selected from the group consisting of: graphite, hard carbon, soft carbon, graphene, carbon nanotube, carbon fiber, and combinations thereof.

In one aspect, the negative electrode may further include greater than or equal to about 0.05 wt. % to less than or equal to about 1 wt. % of single-walled carbon nanotubes (SWCNT).

In one aspect, the electrochemical cell may have a N/P ratio greater than or equal to about 1 to less than or equal to about 1.15.

In various aspects, the present disclosure provides an electrochemical cell that cycles lithium ions. The electrochemical cell may include a positive electrode having a positive electroactive material selected from the group consisting of: LiNiₓM₂₋ₓO₂ (where M is selected from the group consisting of cobalt, manganese, aluminum, and combinations thereof and x≥0.8), a negative electrode having a negative electroactive composite material including a carbonaceous material and silicon oxide (SiOₓ, 0.95≤x≤1.05), and a separator disposed between the positive electrode and the negative electrode. The separator may have a thickness greater than or equal to about 17 μm to less than or equal to about 23 μm. The separator may have a porosity greater than or equal to about 35 vol. % to less than or equal to about 55 vol. %. The electrochemical cell may have a N/P ratio greater than or equal to about 1 to less than or equal to about 1.15.

In one aspect, the positive electrode may have a single-sided loading capacity at room temperature of greater than or equal to about 4.5 mAh/cm² to less than or equal to about 6.5 mAh/cm². The negative electrode may have a single-sided loading capacity at room temperature of greater than or equal to about 4.5 mAh/cm² to less than or equal to about 5.5 mAh/cm².

In one aspect, the electrochemical cell may further include an electrolyte dispersed in one or both of the positive electrode and the negative electrode. The electrochemical cell may also include an electrolyte additive. For example, the electrochemical cell may include greater than or equal to about 0.1 wt. % to less than or equal to about 10 wt. % of the electrolyte additive. The electrochemical cell may be selected from the group consisting of: vinylene carbonate (VC), vinylethylene carbonate (VEC), ethylene sulfate (DTD), 1, 3-propone sulfone (PS), tris(trimethylsilyl) phosphite (TMSPi), trimethylene sulfate (TMS), succinonitrile (SN), triphenylamine (Ph₃N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof.

In one aspect, the negative electrode may have a second width that is at least two times greater than a first width of the positive electrode. The negative electrode may have a second length that is at least two times greater than a first length of the positive electrode. The second width may be less than ten times greater than the first width, and the second length may be less than ten times greater than the first length.

In various aspects, the present disclosure provides an electrochemical cell that cycles lithium ions. The electrochemical cell may include a positive electrode having a positive electroactive material selected from the group consisting of. LiNiₓM₂₋ₓO₂ (where M is selected from the group consisting of cobalt, manganese, aluminum, and combinations thereof and x≥0.8), and a negative electrode having a negative electroactive composite material including a carbonaceous material and silicon oxide (SiOₓ, 0.95≤x≤1.05). The positive electrode may have a single-sided loading capacity at room temperature of greater than or equal to about 4.5 mAh/cm² to less than or equal to about 6.5 mAh/cm². The negative electrode may have a single-sided loading capacity at room temperature of greater than or equal to about 4.5 mAh/cm² to less than or equal to about 5.5 mAh/cm². The negative electrode may have a second width that is at least two times greater than a first width of the positive electrode, and a second length that is at least two times greater than a first length of the positive electrode. The second width may be less than ten times greater than the first width, and the second length may be less than ten times greater than the first length. The electrochemical cell may have a N/P ratio greater than or equal to about 1 to less than or equal to about 1.15.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell;

FIG. 2A is a graphical illustration representing the first cycle charge/discharge curves of an example cell prepared in accordance with various aspects of the present disclosure; and

FIG. 2B is a graphical illustration representing the cycling performance of the example of an example cell prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

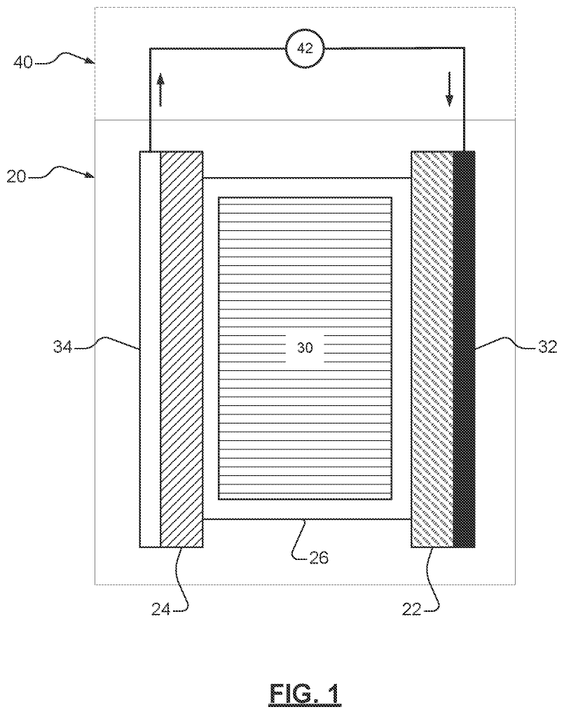

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof. For example, in certain variations, the battery 20 may include five double-sided positive electrodes 24, four double-sided negative electrodes 22, and two single-sided negative electrodes 22.

The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 may be positioned at or near the negative electrode 22. For example, the first current collector 32 may be a negative electrode current collector. The first current collector 32 may be a metal foil, metal grid or screen, or expanded metal comprising copper or any other appropriate electrically conductive material known to those of skill in the art. A second current collector 34 may be positioned at or near the positive electrode 24. For example, the second current collector 34 may be a positive electrode current collector. The second current collector may be a metal foil, metal grid or screen, or expanded metal comprising aluminum or any other appropriate electrically conductive material known to those of skill in the art. The first current collector 32 and the second current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., greater than or equal to about 0.8 M to less than or equal to about 1.2 M, and in certain aspects, optionally about 1 M) that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆Hs)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In certain variations, the electrolyte 30 may further include an electrolyte additive. For example, the electrolyte 30 may include greater than or equal to about 0.1 wt. % to less than or equal to about 10 wt. %, and in certain aspects, optionally greater than or equal to 0.1 wt. % to less than or equal to 10 wt. %, of an electrolyte additive. The electrolyte additive may include vinylene carbonate (VC), vinylethylene carbonate (VEC), ethylene sulfate (DTD), 1, 3-propone sulfone (PS), tris(trimethylsilyl) phosphite (TMSPi), trimethylene sulfate (TMS), succinonitrile (SN), triphenylamine (Ph3N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof.

The separator 26 may have a porosity greater than or equal to about 35 vol. % to less than or equal to about 55 vol. %, and in certain aspects, optionally about 45 vol. %. The separator 26 may have a porosity greater than or equal to 35 vol. % to less than or equal to 55 vol. %, and in certain aspects, optionally 45 vol. %. For example, in certain variations, the porous separator 26 may include a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD®2500 (a monolayer polypropylene separator) and CELGARD®2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic materials and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have a thickness greater than or equal to about 17 μm to less than or equal to about 23 μm, and in certain instances, optionally about 20 μm. The separator 26 may have a thickness greater than or equal to 17 μm to less than or equal to 23 μm, and in certain instances, optionally 20 μm.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃ₓLa_{2/3-x}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof. The solid-state electrolyte particles may be nanometer sized oxide-based solid-state electrolyte particles.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles (not shown). Such positive electroactive material particles may be disposed in one or more layers so as to define the three-dimensional structure of the positive electrode 24. For example, the positive electrode 24 may have a porosity greater than or equal to about 25 vol. % to less than or equal to about 35 vol. %, and in certain aspects, optionally about 30 vol. %. The positive electrode 24 may have a porosity greater than or equal to 25 vol. % to less than or equal to 35 vol. %, and in certain aspects, optionally 30 vol. %. The electrolyte 30 may be introduced, for example after cell assembly, and contained within the pores (not shown) of the positive electrode 24. The positive electrode 24 may have a moisture content (e.g., water content) prior to the introduction of the electrolyte 30 of less than or equal to about 600 ppm. The positive electrode 24 may have a moisture content less than or equal to 600 ppm. In certain variations, the positive electrode 24 may include a plurality of solid-state electrolyte particles (not shown), and the porosity may be defined between both the electroactive material particles and the solids-state electrolyte particles.

In each instance, the positive electrode 24 may have a (first) width (excluding tabs) greater than or equal to about 50 mm to less than or equal to about 500 mm, and in certain aspects, optionally greater than or equal to about 80 mm to less than or equal to about 300 mm. The positive electrode 24 may have a (first) width greater than or equal to 50 mm to less than or equal to 500 mm, and in certain aspects, optionally greater than or equal to 80 mm to less than or equal to 300 mm. The positive electrode 24 may have a (first) length (excluding tabs) greater than or equal to about 50 mm to less than or equal to about 500 mm, and in certain aspects, optionally greater than or equal to about 100 mm to less than or equal to about 400 mm. The positive electrode 24 may have a (first) length greater than or equal to 50 mm to less than or equal to 500 mm, and in certain aspects, optionally greater than or equal to 100 mm to less than or equal to 400 mm. The positive electrode 24 may have a press density greater than or equal to about 3.2 g/cm³ to less than or equal to about 3.8 g/cm³, and in certain aspects, optionally about 3.5 g/cm³. The positive electrode 24 may have a press density greater than or equal to 3.2 g/cm³ to less than or equal to 3.8 g/cm³, and in certain aspects, optionally 3.5 g/cm³.

In various aspects, the positive electrode 24 may be a nickel-rich cathode, where the positive electroactive material includes, for example, LiNiₓM₂₋ₓO₂, where M comprises cobalt, manganese, and/or aluminum and x≥0.8. In other variations, the positive electroactive materials may include, for example, LMO₂, where M comprises cobalt, manganese, and/or aluminum. In still other variations, the positive electroactive material may include, for example, a mixture of LiNiₓM₂₋ₓO₂ (where M comprises cobalt, manganese, and/or aluminum and x≥0.8) and LMO₂ (where M comprises cobalt, manganese, and/or aluminum). In each instance, LMO₂ includes single crystal particles and secondary particles. Single crystal particles are crystallite (i.e., single crystal without any grain boundaries) having an average particle size greater than or equal to about 1 μm to less than or equal to about 50 μm, and in certain aspects, optionally greater than or equal to 1 μm to less than or equal to 50 μm. Secondary particles have an average particle size greater than or equal to about 1 μm to less than or equal to about 50 μm, and in certain aspects, optionally greater than or equal to 1 μm to less than or equal to 50 μm, where each secondary particle comprises a plurality of smaller particles. The smaller particles are often nano-sized having an average particle size greater than or equal to about 30 nm to less than or equal to about 300 nm, and in certain aspects, optionally greater than or equal to 30 nm to less than or equal to 300 nm.

In each variation, the positive electrode 24 may have a capacity loading greater than or equal to about 4.5 mAh/cm² to less than or equal to about 5.5 mAh/cm², and in certain aspects, optionally about 5 mAh/cm², for a single-sided cathode 0.1 C-rate at room temperature (e.g., about 20° C., or optionally about 21° C.). The positive electrode 24 may have a capacity loading greater than or equal to 4.5 mAh/cm² to less than or equal to 5.5 mAh/cm², and in certain aspects, optionally 5 mAh/cm², for a single-sided cathode 0.1 C-rate at room temperature. The positive electrode 24 may have a first cycle efficiency of greater than or equal to about 87% at a voltage greater than about 3.0 V to less than or equal to about 4.2 V.

In further variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s), electronically conductive material, and/or polymeric binder material may be dispersed in a non-aqueous solvent (e.g., N-Methyl-2-pyrrolidone (NMP)) to form a stable slurry for electrode casting and formation of the positive electrode 24.

The positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials and/or binders may be used.

The positive electrode 24 may include greater than or equal to about 5 wt. % to less than or equal to about 99 wt. %, optionally greater than or equal to about 10 wt. % to less than or equal to about 99 wt. %, optionally greater than or equal to about 50 wt. % to less than or equal to about 98 wt. %, and in certain aspects, optionally greater than or equal to about 90 wt. % to less than or equal to about 95 wt. %, of the positive electroactive material(s); greater than or equal to 0 wt. % to less than or equal to about 40 wt. %, optionally greater than or equal to about 1 wt. % to less than or equal to about 20 wt. %, and in certain aspects, optionally greater than or equal to about 1 wt. % to less than or equal to about 5 wt. %, of the electronically conducting material; and greater than or equal to 0 wt. % to less than or equal to about 40 wt. %, optionally greater than or equal to about 1 wt. % to less than or equal to about 20 wt. %, and in certain aspects, optionally greater than or equal to about 1 wt. % to less than or equal to about 5 wt. %, of the at least one polymeric binder.

The positive electrode 24 may include greater than or equal to 5 wt. % to less than or equal to 99 wt. %, optionally greater than or equal to 10 wt. % to less than or equal to 99 wt. %, optionally greater than or equal to 50 wt. % to less than or equal to 98 wt. %, and in certain aspects, optionally greater than or equal to 90 wt. % to less than or equal to 95 wt. %, of the positive electroactive material(s); greater than or equal to 0 wt. % to less than or equal to 40 wt. %, optionally greater than or equal to 1 wt. % to less than or equal to 20 wt. %, and in certain aspects, optionally greater than or equal to 1 wt. % to less than or equal to 5 wt. %, of the electronically conducting material; and greater than or equal to 0 wt. % to less than or equal to 40 wt. %, optionally greater than or equal to 1 wt. % to less than or equal to 20 wt. %, and in certain aspects, optionally greater than or equal to 1 wt. % to less than or equal to 5 wt. %, of the at least one polymeric binder.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. For example, the negative electrode 22 may have a porosity greater than or equal to about 30 vol. % to less than or equal to about 40 vol. %, and in certain aspects, optionally about 35 vol. %. The negative electrode 22 may have a porosity greater than or equal to 30 vol. % to less than or equal to 40 vol. %, and in certain aspects, optionally 35 vol. %. The electrolyte 30 may be introduced, for example after cell assembly, and contained within pores (not shown) of the negative electrode 22. The negative electrode 22 may have a moisture content (prior to the introduction of the electrolyte 30) of less than or equal to about 500 ppm. The negative electrode 22 may have a moisture content less than or equal to 500 ppm. In certain variations, the negative electrode 22 may include a plurality of solid-state electrolyte particles (not shown), and the porosity may be defined between both the electroactive material particles and the solids-state electrolyte particles.

In each instance, the negative electrode 22 has a (second) width that is greater than a (first) width of the positive electrode 24. For example, the (second) width of the negative electrode 22 may be at least about 2 mm greater than the (first) width of the positive electrode 24. The (second) width of the negative electrode 22 may be at least 2 mm greater than the (first) width of the positive electrode 24. The (second) width of the negative electrode 22 may be less than about 10 mm greater than the (first) width of the positive electrode 24. The (second) width of the negative electrode 22 may be less than 10 mm greater than the (first) width of the positive electrode 24. For example, the negative electrode 22 may have a (second) width greater than or equal to about 50 mm to less than or equal to about 500 mm, and in certain aspects, optionally greater than or equal to about 80 mm to less than or equal to about 300 mm. The negative electrode 22 may have a (second) width greater than or equal to 50 mm to less than or equal to 500 mm, and in certain aspects, optionally greater than or equal to 80 mm to less than or equal to 300 mm.

The negative electrode 22 may have a (second) length that is greater than a (first) length of the positive electrode 24. The (second) length of the negative electrode 22 may be at least about 2 mm greater than the (first) length of the positive electrode 24. The (second) length of the negative electrode 22 may be at least 2 mm greater than the (first) length of the positive electrode 24. The (second) length of the negative electrode 22 may be less than about 10 mm greater than the (first) length of the positive electrode 24. The (second) length of the negative electrode 22 may be less than 10 mm greater than the (first) length of the positive electrode 24. For example, the negative electrode 22 may have a (second) length greater than or equal to about 50 mm to less than or equal to about 500 mm, and in certain aspects, optionally greater than or equal to about 100 mm to less than or equal to about 400 mm. The negative electrode 22 may have a (second) length greater than or equal to 50 mm to less than or equal to 500 mm, and in certain aspects, optionally greater than or equal to 100 mm to less than or equal to 400 mm.

The negative electrode 22 may have a press density greater than or equal to about 1.4 g/cm³ to less than or equal to about 1.8 g/cm³, and in certain aspects, optionally about 1.6 g/cm³. The negative electrode 22 may have a press density greater than or equal to 1.4 g/cm³ to less than or equal to 1.8 g/cm³, and in certain aspects, optionally 1.6 g/cm³.

In various aspects, the negative electroactive material may be a silicon-based electroactive material, and in further variations, the negative electroactive material may include a combination of the silicon-based electroactive material (i.e., first negative electroactive material) and one or more other negative electroactive materials. The one or more other negative electroactive materials include, for example only, carbonaceous materials (such as, graphite, hard carbon, soft carbon, and the like). For example, in certain variations, the negative electroactive material may be a carbonaceous-silicon based composite including, for example, greater than or equal to about 92 wt. % to less than or equal to about 98 wt. %, and in certain aspects, optionally greater than or equal to 92 wt. % to less than or equal to 98 wt. %, of graphite, and greater than or equal to about 2 wt. % to less than or equal to about 8 wt. %, and in certain aspects, optionally greater than or equal to 2 wt. % to less than or equal to 8 wt. %, of silicon oxide (SiOₓ, 0.95≤x≤1.05). In each variation, the negative electrode 22 may have a capacity loading greater than or equal to about 4.5 mAh/cm² to less than or equal to about 6.5 mAh/cm², and in certain aspects, optionally about 5.5 mAh/cm², for a single-sided anode 0.1 C-rate at room temperature. The negative electrode 22 may have a capacity loading greater than or equal to 4.5 mAh/cm² to less than or equal to 6.5 mAh/cm², and in certain aspects, optionally 5.5 mAh/cm², for a single-sided anode 0.1 C-rate at room temperature. The negative electrode 22 may have a first cycle efficiency of greater than or equal to about 89% at a voltage greater than 0 V to less than or equal to about 1.5 C

The graphite may have an average particle size (D50) greater than or equal to about 8 μm to less than or equal to about 20 μm, and in certain aspects, optionally greater than or equal to 8 μm to less than or equal to 20 μm. The graphite may have a Brunauer, Emmett and Teller (“BET”) greater than or equal to about 1 m²/g to less than or equal to about 10 m²/g, and in certain aspects, optionally greater than or equal to 1 m² to less than or equal to 10 m². The graphite may have a tap density (“TD”) greater than or equal to about 0.5 g/cc to less than or equal to about 1 g/cc, and in certain aspects, optionally greater than or equal to 0.5 g/cc to less than or equal to 1 g/cc.

The silicon oxide may have an average particle size (D50) greater than or equal to about 3 μm to less than or equal to about 10 μm, and in certain aspects, optionally greater than or equal to 3 μm to less than or equal to 10 μm. The silicon oxide may have a Brunauer, Emmett and Teller (“BET”) greater than or equal to about 1 m² to less than or equal to about 10 m², and in certain aspects, optionally greater than or equal to 1 m² to less than or equal to 10 m². The silicon oxide may have a tap density (“TD”) greater than or equal to about 1.0 g/cc to less than or equal to about 1.5 g/cc, and in certain aspects, optionally greater than or equal to 1.0 g/cc to less than or equal to 1.5 g/cc.

In certain variations, the negative electroactive material(s) in the negative electrode 22 may be optionally intermingled with single-walled carbon nanotubes (SWCNT). For example, the negative electrode 22 may include greater than or equal to about 0.05 wt. % to less than or equal to about 1 wt. %, and in certain aspects, optionally greater than or equal to 0.05 wt. % to less than or equal to 1 wt. %, of the single-walled carbon nanotubes (SWCNT).

In still further variations, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s), electronically conductive material, and/or polymeric binder material may be dispersed in water to form a stable slurry for electrode casting and formation of the negative electrode 22.

The negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode may include greater than or equal to about 5 wt. % to less than or equal to about 99 wt. %, optionally greater than or equal to about 10 wt. % to less than or equal to about 99 wt. %, optionally greater than or equal to about 50 wt. % to less than or equal to about 98 wt. %, and in certain aspects, optionally greater than or equal to about 90 wt. % to less than or equal to about 95 wt. %, of the negative electroactive material(s); greater than or equal to 0 wt. % to less than or equal to about 40 wt. %, optionally greater than or equal to about 1 wt. % to less than or equal to about 20 wt. %, and in certain aspects, optionally greater than or equal to about 1 wt. % to less than or equal to about 5 wt. %, of the electronically conducting material; and greater than or equal to 0 wt. % to less than or equal to about 40 wt. %, optionally greater than or equal to about 1 wt. % to less than or equal to about 20 wt. %, and in certain aspects, optionally greater than or equal to about 1 wt. % to less than or equal to about 5 wt. %, of the at least one polymeric binder.

The negative electrode 22 may include greater than or equal to 5 wt. % to less than or equal to 99 wt. %, optionally greater than or equal to 10 wt. % to less than or equal to 99 wt. %, optionally greater than or equal to 50 wt. % to less than or equal to 98 wt. %, and in certain aspects, optionally greater than or equal to 90 wt. % to less than or equal to 95 wt. %, of the negative electroactive material(s); greater than or equal to 0 wt. % to less than or equal to 40 wt. %, optionally greater than or equal to 1 wt. % to less than or equal to 20 wt. %, and in certain aspects, optionally greater than or equal to 1 wt. % to less than or equal to 5 wt. %, of the electronically conducting material; and greater than or equal to 0 wt. % to less than or equal to 40 wt. %, optionally greater than or equal to 1 wt. % to less than or equal to 20 wt. %, and in certain aspects, optionally greater than or equal to 1 wt. % to less than or equal to 5 wt. %, of the at least one polymeric binder.

In various aspects, the battery 20 may have a negative electrode capacity and/or positive electrode capacity ratio (N/P) ratio greater than or equal to about 1 to less than or equal to about 1.15, and in certain aspects, optionally greater than or equal to 1 to less than or equal to 1.15.

Certain features of the current technology are further illustrated in the following non-limiting examples.

### Example 1

An example cell can be prepared in accordance with various aspects of the present disclosure. For example, a positive electroactive material may include LiNiₓM₂₋ₓO₂, where M comprises cobalt, manganese, and/or aluminum and x≥0.8 (e.g., LiNiCoMnAlO₂ (NCMA)), and a negative electroactive material may include graphite and silicon (e.g., 5 wt. % SiOₓ (0.95≤x≤1.05) and 95 wt. % graphite), as detailed above.

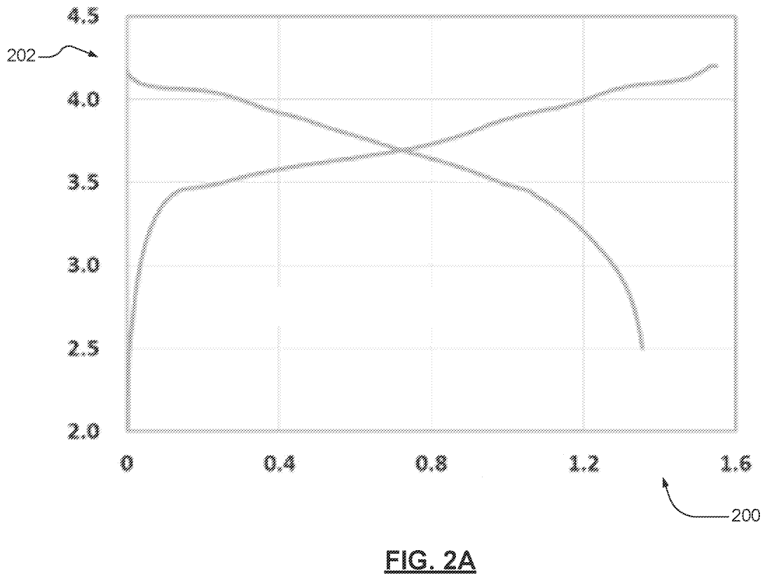

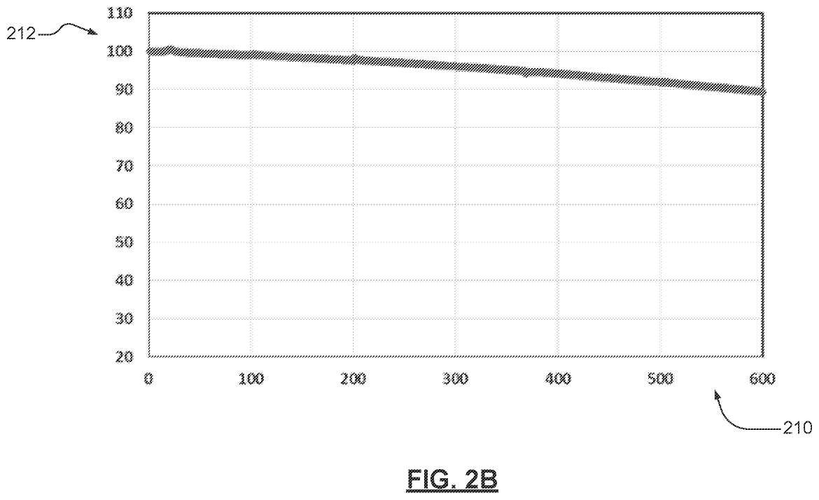

FIG. 2A is a graphical illustration representing the first cycle charge/discharge curves of the example cell, where the x-axis 200 represents capacity (Ah), and the y-axis 202 represents voltage (V).

FIG. 2B is a graphical illustration representing the cycling performance (at room temperature) of the example cell, where the x-axis 210 represents cycle number, and the y-axis 212 represents discharge capacity retention (%). As illustrated, retention after 600 cycles is about 89%.

A batteries prepared in accordance with various aspects of the present disclosure may have comparatively high power capabilities as a result of reduced electrode thicknesses, comparatively high energy density as a result of the high specific capacity of both the positive and negative electrodes (and as such, situatable for electrodes with comparatively high loadings), and limited volumetric expansion because at least a portion of the volumetric expansion in the negative electrodes may be offset by the nickel-rich positive electrodes.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, wherein the electrochemical cell comprises:
a positive electrode having a single-sided loading capacity at room temperature of greater than or equal to about 4.5 mAh/cm² to less than or equal to about 6.5 mAh/cm², wherein the positive electrode comprises a positive electroactive material selected from the group consisting of: LiNiₓM₂₋ₓO₂ (where M is selected from the group consisting of cobalt, manganese, aluminum, and combinations thereof and x≥0.8); and
a negative electrode having a single-sided loading capacity at room temperature of greater than or equal to about 4.5 mAh/cm² to less than or equal to about 5.5 mAh/cm², wherein the negative electrode comprises a negative electroactive composite material comprising a carbonaceous material and silicon oxide (SiOₓ, 0.95≤x≤1.05).

2. The electrochemical cell of claim 1, wherein the positive electrode has a press density greater than or equal to about 3.2 g/cm³ to less than or equal to about 3.8 g/cm³, and a porosity greater than or equal to about 25 vol. % to less than or equal to about 35 vol. %.

3. The electrochemical cell of claim 1, wherein the positive electrode has a width greater than or equal to about 50 mm to less than or equal to about 500 mm, and a length greater than or equal to about 50 mm to less than or equal to about 500 mm.

4. The electrochemical cell of claim 1, wherein the positive electrode has a moisture content of less than or equal to about 600 ppm.

5. The electrochemical cell of claim 1, further comprising:
a separator disposed between the positive electrode and the negative electrode, wherein the separator has a thickness greater than or equal to about 17 micrometers to less than or equal to about 23 micrometers and a porosity greater than or equal to about 35 vol. % to less than or equal to about 55 vol. %.

6. The electrochemical cell of claim 1, further comprising:
an electrolyte dispersed in one or both of the positive electrode and the negative electrode; and
an electrolyte additive selected from the group consisting of vinylene carbonate (VC), vinylethylene carbonate (VEC), ethylene sulfate (DTD), 1, 3-propone sulfone (PS), tris(trimethylsilyl) phosphite (TMSPi), trimethylene sulfate (TMS), succinonitrile (SN), triphenylamine (Ph₃N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof, wherein the electrochemical cell comprises greater than or equal to about 0.1 wt. % to less than or equal to about 10 wt. % of the electrolyte additive.

7. The electrochemical cell of claim 1, wherein the negative electrode has a press density greater than or equal to about 1.4 g/cm³ to less than or equal to about 1.8 g/cm³, and a porosity greater than or equal to about 30 vol. % to less than or equal to about 40 vol. %.

8. The electrochemical cell of claim 1, wherein the negative electrode has a second width that is at least two times greater than a first width of the positive electrode, and a second length that is at least two times greater than a first length of the positive electrode.

9. The electrochemical cell of claim 8, wherein the second width is less than ten times greater than the first width, and the second length is less than ten times greater than the first length.

10. The electrochemical cell of claim 8, wherein the negative electrode has a width greater than or equal to about 50 mm to less than or equal to about 500 mm, and a length greater than or equal to about 50 mm to less than or equal to about 500 mm.

11. The electrochemical cell of claim 1, wherein the negative electrode has a moisture content of less than or equal to about 500 ppm.

12. The electrochemical cell of claim 1, wherein the negative electrode comprises greater than or equal to about 92 wt. % to less than or equal to about 98 wt. % of the carbonaceous material, and greater than or equal to about 2 wt. % to less than or equal to about 8 wt. % of silicon oxide (SiOₓ, 0.95≤x≤1.05).

13. The electrochemical cell of claim 1, wherein the carbonaceous material is selected from the group consisting of graphite, hard carbon, soft carbon, graphene, carbon nanotube, carbon fiber, and combinations thereof.

14. The electrochemical cell of claim 1, wherein the negative electrode further comprises greater than or equal to about 0.05 wt. % to less than or equal to about 1 wt. % of single-walled carbon nanotubes (SWCNT).

15. The electrochemical cell of claim 1, wherein the electrochemical cell has a N/P ratio greater than or equal to about 1 to less than or equal to about 1.15.

16. An electrochemical cell that cycles lithium ions, wherein the electrochemical cell comprises:
a positive electrode having a positive electroactive material selected from the group consisting of LiNiₓM₂₋ₓO₂ (where M is selected from the group consisting of cobalt, manganese, aluminum, and combinations thereof and x≥0.8),
a negative electrode having a negative electroactive composite material comprising a carbonaceous material and silicon oxide (SiOₓ, 0.95≤x≤1.05); and
a separator disposed between the positive electrode and the negative electrode, wherein the separator has a thickness greater than or equal to about 17 micrometers to less than or equal to about 23 micrometers and a porosity greater than or equal to about 35 vol. % to less than or equal to about 55 vol. %,
wherein the electrochemical cell has a N/P ratio greater than or equal to about 1 to less than or equal to about 1.15.

17. The electrochemical cell of claim 16, wherein the positive electrode has a single-sided loading capacity at room temperature of greater than or equal to about 4.5 mAh/cm² to less than or equal to about 6.5 mAh/cm², and
wherein the negative electrode having a single-sided loading capacity at room temperature of greater than or equal to about 4.5 mAh/cm² to less than or equal to about 5.5 mAh/cm².

18. The electrochemical cell of claim 16, further comprising:
an electrolyte dispersed in one or both of the positive electrode and the negative electrode; and
an electrolyte additive selected from the group consisting of vinylene carbonate (VC), vinylethylene carbonate (VEC), ethylene sulfate (DTD), 1, 3-propone sulfone (PS), tris(trimethylsilyl) phosphite (TMSPi), trimethylene sulfate (TMS), succinonitrile (SN), triphenylamine (Ph₃N), tris(trimethylsilyl)borate (TMSB), tris(trimethylsilyl)phosphate (TMSP), triphenyl phosphine (TPP), triethyl phosphite (TEP), trimethyl borate (TMB), and combinations thereof, wherein the electrochemical cell comprises greater than or equal to about 0.1 wt. % to less than or equal to about 10 wt. % of the electrolyte additive.

19. The electrochemical cell of claim 1, wherein the negative electrode has a second width that is at least two times greater than a first width of the positive electrode, and a second length that is at least two times greater than a first length of the positive electrode, and
wherein the second width is less than ten times greater than the first width, and the second length is less than ten times greater than the first length.

20. An electrochemical cell that cycles lithium ions, wherein the electrochemical cell comprises:
a positive electrode having a positive electroactive material selected from the group consisting of LiNiₓM₂₋ₓO₂ (where M is selected from the group consisting of cobalt, manganese, aluminum, and combinations thereof and x≥0.8), wherein the positive electrode has a single-sided loading capacity at room temperature of greater than or equal to about 4.5 mAh/cm² to less than or equal to about 6.5 mAh/cm²; and
a negative electrode having a negative electroactive composite material comprising a carbonaceous material and silicon oxide (SiOₓ, 0.95≤x≤1.05), the negative electrode having a single-sided loading capacity at room temperature of greater than or equal to about 4.5 mAh/cm² to less than or equal to about 5.5 mAh/cm²,
wherein the negative electrode has a second width that is at least two times greater than a first width of the positive electrode, and a second length that is at least two times greater than a first length of the positive electrode,
wherein the second width is less than ten times greater than the first width, and the second length is less than ten times greater than the first length, and
wherein the electrochemical cell has a N/P ratio greater than or equal to about 1 to less than or equal to about 1.15.
